(19) United States
(12) Patent Application Publication
(10) Pub. No.: US 2011/0312098 A1
(43) Pub. Date: Dec. 22, 2011

(54) SYSTEM AND METHOD OF ASSESSING NANOTUBE PURITY

(75) Inventors: Weijun Wang, Dublin, OH (US); Srinagesh K. Potluri, Dublin, OH (US); Yongfeng Wang, Dublin, OH (US); Iti Srivastava, Columbus, OH (US)

(73) Assignee: ZYVEX PERFORMANCE MATERIALS, Columbus, OH (US)

(21) Appl. No.: 13/111,408

(22) Filed: May 19, 2011

Related U.S. Application Data
(60) Provisional application No. 61/346,253, filed on May 19, 2010.

(51) Int. Cl. G01N 21/59; C08F 138/00

(52) U.S. Cl. 436/85; 526/242

(57) ABSTRACT

The present invention is directed to methods for assessing the purity of carbon nanotube (CNT) compositions, specifically, a method for assessing the presence of contaminants in a CNT composition using polyaryl ethynyl (PAE) conjugate polymer as an indicator material. Additionally, compositions and kits comprising a polyaryl ethynyl (PAE) conjugate polymer are also provided.

### CROSS-REFERENCE TO RELATED APPLICATIONS

This application claims priority from U.S. Provisional application Ser. No. 61/346,253, filed May 19, 2010.

### TECHNICAL FIELD

The present disclosure is directed to methods for assessing the purity of carbon nanotube (CNT) compositions, specifically, a method for assessing the presence of contaminants in a CNT composition using a polymer as an indicator material.

### BACKGROUND

Carbon nanotubes (CNTs) are revolutionary materials having valuable electrical, optical, mechanical, and thermal characteristics due to their unique quasi-one-dimensional electron confinement. Despite more than 15 years of R&D, obtaining CNTs of consistent, suitable purities has been problematic. Industrial companies claim they are expanding and refining their processes, yet if one purchases CNTs on the open market, more often than not one obtains a vial of unlabeled, uncharacterized material. Often, CNTs are provided as a mixture of species, along with unwanted chemical impurities (3-50%). Pure nanotubes is one of the principal barriers to significant adaptation of CNTs in a wide range of industries, including, but not limited to, nanoelectronics, nanobiotechnology, and general nanomaterials (e.g., nanocomposites).

Technologies incorporating CNTs thus confront quality issues at every level, ranging from composite manufacturers integrating CNTs into high-strength structures, to the next generation of optical sources, detectors, and displays. Advanced, cost-effective analytical techniques are needed so that CNT manufacturers, product developers, and regulatory agencies can truly “see” what they have and obtain what they truly need.

Fundamental limitations encountered with off-the-shelf instrumentation applied to carbon nanotube metrology include: limits to information attainable; quantitativeness of results; cost, including capital, ownership, and training; complexity of measurement, including sample preparation; system reliability; sample matrices and sample destructiveness.

Electron microscopy and thermo gravimetric analysis (TGA) for quality control (QC) of CNTs are commonly used methods. However, these methods are not very reliable due to the small sample size and high cost incurred in performing these tests. It is therefore desirable to provide systems and methods for quantifying impurities in CNT compositions. It is also desirable for the systems and methods to be inexpensive and rapid.

To address these issues, a quick, easy and economical method for bulk QC of CNTs has been developed using a newly designed polyaryl ethynyls (PAE) conjugate polymer based on Kentera™. The new method is based on the fluorescence quenching of the color emission of the PAE conjugate polymer. Thus, the PAE conjugate polymer is used as an indicator to assess the purity of CNTs.

### SUMMARY OF INVENTION

In one aspect of the invention, a method of determining carbon nanotube (CNT) quality is provided. The method comprises adding a polyaryl ethynyl (PAE) conjugate polymer capable of interacting with CNT by pi stacking, and results in the dissolution of CNT in solvents, to a CNT composition and a solvent to result in dissolution of CNT in an assay solution; filtering the assay solution; measuring the absorbance of the assay solution; determining the concentration of free PAE conjugate polymer based on the absorbance of the assay solution; and determining the amount of impurities in the CNT based on the concentration of free PAE conjugate polymer, where the amount of impurities in the CNT determines CNT quality.

In another aspect of the invention, a composition comprising a modified polyaryl ethynyl (PAE) conjugate polymer is provided. In various embodiments, the electron density on the modified PAE conjugate polymer backbone is modulated by selecting a desired balance of electron-donating and/or withdrawing side chains. In one embodiment, the PAE conjugate polymer comprises poly(phenyleneethynylene).

### DETAILED DESCRIPTION

Carbon nanotubes (CNTs) are commonly fabricated from graphite through processes generally known to a person of ordinary skill in the art as electric arc discharge, HIPCO (High-Pressure CO), laser-desorption, laser-ablation, plasma (PVD) or chemical vapor deposition (CVD). Following these treatments, the initial material adopts a highly orderly structure constituted by one wall (single-wall carbon nanotubes (SWNT)) or several walls (multi-wall carbon nanotubes (MWNT)) with miniaturized cylindrical shape varying in diameter and length according to the type of treatment, in which the carbon atoms combined together form a prevalently hexagonal honeycomb pattern. The typical diameter of a nanotube ranges from about 1 nm to 10 nm. The length of a nanotube potentially can be millions of times greater than its diameter.

The term “nanotubes” is used broadly herein and, unless otherwise qualified, is intended to encompass any type of nanomaterial. The term “nanomaterial,” as used herein, includes, but is not limited to, multi-wall carbon (MWNTs), single-wall carbon (SWNTs), carbon nanoparticles, carbon nanofibers, carbon nanoropes, carbon nanoribbons, carbon nanofibrils, carbon nanoneedles, carbon nanosheets, carbon nanorods, carbon nanohorns, carbon nanocones, carbon nanoscrolls, graphite nanoplatelets, graphene, nanodots, other fullerene materials, or a combination thereof. The term “nanomaterial” includes materials having conjugated aromatic rings which allow interaction with PAE conjugate polymer by pi-pi stacking.

Generally, a “nanotube” is a tubular, strand-like structure that has a circumference on the atomic scale. For example, the diameter of single walled nanotubes typically range from approximately 0.4 nanometers (nm) to approximately 100 nm, and most typically have diameters ranging from approximately 0.7 nm to approximately 5 nm.

While the term “SWNTs,” is an acronym describing single walled nanotubes, the term as used herein, unless otherwise stated, also refers generally to other nanomaterials that are selectable by a person of ordinary skill in the art. Carbon nanomaterials, such as CNTs, are useful in numerous applications, such as, for example, catalyst supports in heterogeneous catalysis, high strength engineering fibers and as a reinforcement component in composites.

CNTs can be conducting or metallic or with a slight change in geometry, semi-conducting. A person of ordinary skill in the art can appreciate that CNTs are used in electronic and opto-electronic equipment (electrical and electronic microcircuits, diodes, transistors, sensors, field emission displays, vacuum fluorescent displays or sources of white light), and also polymeric compound materials with high electrical, thermal and mechanical strength.

Nanomaterials, such as CNTs, are extremely stable and chemically inert and therefore suffer from low solubility. This barrier inhibits widespread application of CNTs because, for example, CNTs have a tendency to clump rather than disperse when placed in a polymer matrix. The low solubility of CNTs are due, in part, to powerful van der Waals forces generated along the surface between adjoining CNTs, contributing to aggregation of CNTs. The difficulty in manipulating CNTs in a host matrix results in limited application of CNTs. Furthermore, aggregation of CNTs makes it difficult to assess the magnitude of impurities in a CNT composition.

PAE (polyaryl ethynyls) conjugate polymers interact with CNTs by pi stacking and result in dissolution of CNTs in solvents. The efficiency of interaction depends on the electron density at the polymer backbone of the PAE conjugate polymer. The pi stacking can be illustrated by induced dipole-dipole interaction between the PAE conjugate polymer and electron-rich CNTs. PAE conjugate polymer electron-donating side chains increase the electron density on the polymer backbone and induce greater polarization of the charge cloud on the CNTs and result in dipoles on both PAE conjugate polymer and CNT. The resulting strong dipoles will result in strong attraction between the polymer and CNTs. However, the attractive force of the PAE conjugate polymer is so strong that the PAE conjugate polymer does not discriminate between CNTs and other carbon and metal catalyst impurities associated with the CNTs. The resulting CNT solvent dispersions have carbon and/or metal catalyst impurities well dispersed in solvent.

In one embodiment, the present invention is directed to methods for assessing impurities in a carbon nanotube (CNT) composition using a polyaryl ethynyl (PAE) conjugate polymer as an indicator for the presence of impurities. In one aspect of the invention, the electron density on the PAE conjugate polymer backbone is modulated by selecting a desired balance of both electron-donating and withdrawing side chains. One object of the modifications to the PAE conjugate polymer backbone is to maintain tight interactions with CNTs while decreasing the ability of the PAE conjugate polymer to tightly interact with impurities in the CNT composition. In this way, the amount of free PAE conjugate polymer is inversely proportional to the amount of CNT and indirectly proportional to the amount of impurities in the CNT composition. For example, using generic terms, if 10 arbitrary units of a CNT composition comprises 9 arbitrary units of CNT and 1 arbitrary unit of impurities, and this composition is combined with 10 arbitrary units of modified PAE conjugate polymer, 9 arbitrary units of the modified PAE conjugate polymer will interact with the CNT, leaving 1 arbitrary unit of free modified PAE conjugate polymer. In contrast, when a second CNT composition having 5 arbitrary units of CNT and 5 arbitrary units of impurities is combined with 10 arbitrary units of modified PAE conjugate polymer, 5 arbitrary units of the modified PAE conjugate polymer will interact with the CNT, leaving 5 arbitrary unit of free modified PAE conjugate polymer. Thus, an increase in free modified PAE conjugate polymer is an indicator of a decrease in CNT, and thus an increase in impurities in the CNT composition.

In order to reduce electron density on the backbone of PAE conjugate polymer and increase the attraction towards the ladder structure, also referred as a hexagonal honeycomb pattern, of CNT carbon-carbon bonds which are rich in free electrons, electron-withdrawing functional groups are introduced onto the branches of the modified PAE conjugate polymer. In contrast, impurities and amorphous carbon do not have perfect ladder structures of carbon-carbon bonds, thus they do not have strong interaction with the PAE conjugate polymer. The optimized electron density on the modified PAE conjugate polymer will enable the polymer to preferentially interact with and disperse CNTs over carbon and catalytic impurities.

CNTs with high electron density can interact with the modified PAE conjugate polymer efficiently. The modified PAE conjugate polymer does not discriminate between CNTs of various diameters. However, the relative ratios of modified PAE conjugate polymer and CNTs depend on the polarizability of the CNT charge cloud, which depends on how the graphene layers fold to form the tubes and the surface energies of the CNTs.

An electron withdrawing group or EWG draws electrons away from aromatic center. The group generally has a hetero atom with multiple bonds or halogens. An electron releasing group or ERG (otherwise called electron donating groups or EDG) releases electrons into the aromatic structure. The group generally has hetero atoms with no double bonds attached to it. Alkyl groups with no halogens can also be EDG. The PAE conjugate polymer can be modified by adding electron-withdrawing groups such as fluorinated alkyl, fluorinated aromatics, nitro, carboxy, nitrile, amido, and/or carbonyl groups. In one embodiment, the PAE conjugate polymer is modified by adding electron donating groups such as alkyl, phenyl, benzyl, aryl, and/or allyl groups. In one embodiment, the PAE conjugate polymer is modified by adding hydrogen, polyamine, olefin, ether, crown ether, epoxy, ethylene glycohol, and/or amine groups. In one embodiment, the PAE conjugate polymer is modified by adding a combination of groups, such as electron donating and electron withdrawing groups.

In one embodiment, the PAE conjugate polymer is poly(phenyleneethynylene) having the structure Pₐ, P_{b}, P_{c} or a combination thereof:

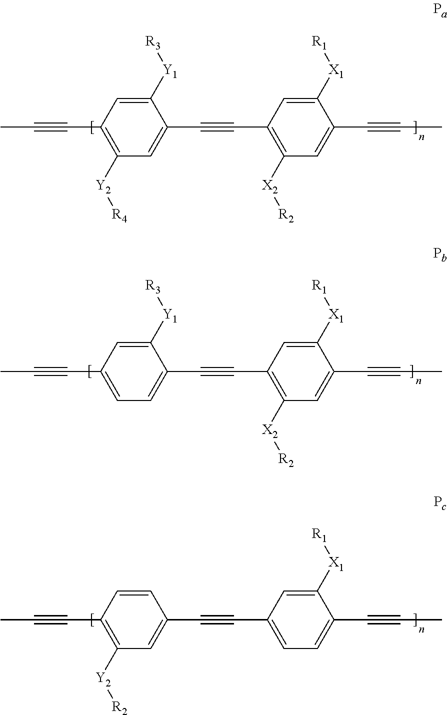

wherein n is from about 20 to about 190; X₁R₁, X₂R₂, Y₁R₃, Y₂R₄, and Y₂R₂ are either electron donating or electron withdrawing substituents; when the poly(phenyleneethynylene) has the structure Pₐ and when X₁R₁ and X₂R₂ are electron donating, then Y₁R₃ and Y₂R₄ are electron withdrawing, and when X₁R₁ and X₂R₂ are electron withdrawing, then Y₁R₃ and Y₂R₄ are electron donating; when the poly(phenyleneethynylene) has the structure P_{b} and when X₁R₁ and X₂R₂ are electron donating, then Y₁R₃ is electron withdrawing, and when X₁R₁ and X₂R₂ are electron withdrawing, then Y₁R₃ is electron donating; when the poly(phenyleneethynylene) has the structure P_{c} and when X₁R₁ is electron donating, then Y₂R₂ is electron withdrawing, and when X₁R₁ is electron withdrawing, then Y₂R₂ is electron donating; X₁, X₂, Y₁, and Y₂ are independently CO, COO, CONH, CONHCO, COOCO, CONHCNH, CON, COS, CS, alkyl, aryl, allyl, N, NO, S, O, SO, CN, CNN, SO₂, P, or PO; and R₁-R₄ are independently alkyl, Z-substituted alkyl, phenyl, Z-substituted phenyl, benzyl, Z-substituted benzyl, aryl, Z-substituted aryl, allyl, Z-substituted allyl or hydrogen, wherein Z is independently an acetal, acid halide, acrylate unit, acyl azide, aldehyde, anhydride, cyclic alkane, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, polyimine (2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine), polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof. In various embodiments, the electron withdrawing group is perfluorinated alkyl.

In one embodiment, the molecular weight of the modified PAE conjugate polymer is between about 15,000 Da to about 450,000 Da. In one embodiment, the modified PAE conjugate polymer has a polydispersity index (PDI) of between about 1.5 to about 10. Polydispersity index is a measure of the distribution of the molecular mass of the modified PAE conjugate polymer.

Various impurities, either alone or in combination, can be found in CNT compositions, such as amorphous carbon, and transition metal catalyst like iron, cobalt, molybdenum, and aluminum oxide substrates. The amount of impurities in a CNT composition can vary, and the described method is compatible with the percentages of impurities found in CNT compositions.

In one embodiment, the amount of free modified PAE conjugate polymer is a measure of impurities associated with CNTs. The quality of a CNT composition is related to the amount of impurities in a CNT composition, such that a high quality CNY composition has a relatively low amount of impurities. The concentration of free modified PAE conjugate polymer is measured by UV visible spectroscopy. The wavelength of the absorbance of the assay solution containing the modified PAE conjugate polymer varies based on the modifications of the polymer, and can readily be determined by a person having ordinary skill in the art. In one embodiment, the absorbance of a fluorinated PAE conjugate polymer is measured at about 465 nm wavelength. In one embodiment, measurement of free modified PAE conjugate polymer is determined after filtering the CNT composition and modified PAE conjugate polymer mixture.

In one embodiment, the absorbance of a first solution containing a CNT composition to be tested is compared to a second solution containing a control or standard CNT composition, and the quality of the first CNT composition is determined by comparison to the second CNT composition. The control CNT may have been verified by one of scanning electron microscopy (SEM), transmission electron microscopy (TEM), or thermogravimetric analysis (TGA).

In one embodiment, a method of determining carbon nanotube (CNT) quality comprises adding a polyaryl ethynyl (PAE) conjugate polymer capable of interacting with CNT by pi stacking, and results in the dissolution of CNT in solvents, to a CNT composition and a solvent to result in dissolution of CNT in an assay solution; filtering the assay solution; measuring the absorbance of the assay solution; determining the concentration of free PAE conjugate polymer based on the absorbance of the assay solution; and determining the amount of impurities in the CNT based on the concentration of free PAE conjugate polymer, where the amount of impurities in the CNT determines CNT quality.

In various embodiments, the assay solution comprises a suitable solvent, such as methanol, methyl ethyl ketone (MEK), acetone, chloroform, tetrahydrofuran (THF), organic solvents, and/or water. Dissolution of CNT in the assay solution may be assisted by known means, such as subjecting the assay solution to vibration using a bath or probe sonicator. The assay solution may be filtered by any suitable means, such as a membrane filter, where the filter size is between about 0.5 and about 1 μm.

The amount of PAE conjugate polymer added to the assay solution can be varied depending on the amount CNT in the assay solution. In one embodiment, about 15% to about 20% w/w of the PAE conjugate polymer is added to the assay solution, based on the weight of the CNT.

In one embodiment, a kit containing a described PAE conjugate polymer, and instructions for using the PAE conjugate polymer to assay the purity of a carbon nanotube (CNT) composition, is provided.

The method will be further appreciated with respect to the following non-limiting example.

### Example

The quality of MWNT samples was determined by the mass of a standardized modified PAE conjugate polymer adsorbed onto MWNT.

Pi-pi stacking, belonging to the concept of Wan de Waals force or the concept of physical adsorption, between the modified PAE conjugate polymer and CNTs were well demonstrated by isothermal adsorption. The quantitative adsorption between CNTs and modified PAE conjugate polymer is governed by the quality of CNTs in terms of the diameters and the purity of CNTs. The higher quality of CNTs leaves less amount of free modified PAE conjugate polymer in the filtered solution after the adsorption occurs in a solvent. The concentration of modified PAE conjugate polymer is quantitatively determined by a photo-spectrometer.

Experimental:
1. Solution Preparation
   i. modified PAE conjugate polymer
   ii. Solvent: Chloroform, HPLC grade
2. Equipment
   i. Sonication bath: VWR MODEL 750 D
   ii. Sonication power meter: ULTRASINIC CAVITATION METER
   iii. Stir machine: RW16 basic IKA-WERKE
   iv. Circulation bath: Thermo NESLAB RTE7
   v. Photo-spectrometer: Agilent 8453
3. Procedure
   i. Weigh 18 mg modified PAE conjugate polymer and place into 100 ml volumetric flask.
   ii. Fill methyl ethyl ketone (MEK) into the volumetric flask up to the mark.
   iii. Put magnetic stir bar into the volumetric flask.
   iv. Pour the solution into 250 ml flask of step 4 when modified PAE conjugate polymer is totally dissolved (clear greenish solution).
4. Adsorption procedure:
   i. Weigh 100 mg of CNT and put it into a 250 ml flask
   ii. Pour the solution (finished in step 3) into a 250 ml flask in which 100 mg of MWCNT is weighed after modified PAE conjugate polymer is totally dissolved.
   iii. Put the flask into water bath sonication.
   iv. Adjust the power to highest power (level 9).
   v. Sonicate the solution for 30 min.
   vi. A syringe filter (a glass fiber membrane) is used to remove MWCNT and the filtered solution is ready for concentration measurement of the modified PAE conjugate polymer.
5. Concentration Measurements
6. Turn on the computer and the photo-spectrometer.
7. Turn on the lamps through the computer and warm them up for 45 min.
8. Fill MEK solvent into the cuvette and insert into the cell holder.
9. Click on the Blank button to establish a baseline.
10. Fill the filtered solution into a cuvette.
11. Put the cuvette into the sample holder in the instrument.
12. Click on the Sample button to measure the absorbance of the solution.
13. Record the readings.
14. Save the data into computer.

Criteria for pass:
The quality of MWCNT was regarded as good when the light absorbance is less than 1.

Results:

The comparisons of SEM results with results from the Method

| | | 18% PAE |
|---|---|---|
| Rejected | | polymer* |
| Lot# | SEM | abs CNT/PAE |
| 7104 | Bad | 1.3504 |
| 7110 | Bad | 1.4646 |
| 7128 | Bad | 1.2479 |
| 8038 | Bad | 1.2133 |
| 8095 | Bad | 1.1267 |
| 9074 | Bad | 1.7178 |
| Approved | | |
| Lot# | SEM | |
| 8040 | Good | 0.7641 |
| 8041 | Good | 0.7449 |
| 8092 | Good | 0.7468 |
| 9097 | Good | 0.8874 |
| 9107 | Good | 0.3153 |
| 9108 | Good | 0.8194 |

*the weights of indicator are based on the weight of CNT

What is claimed is:

1. A method of determining carbon nanotube (CNT) quality, the method comprising
adding a polyaryl ethynyl (PAE) conjugate polymer capable of interacting with CNT by pi stacking, and results in the dissolution of CNT in solvents, to a CNT composition and a solvent to result in dissolution of CNT in an assay solution;
filtering the assay solution;
measuring the absorbance of the assay solution;
determining the concentration of free PAE conjugate polymer based on the absorbance of the assay solution; and
determining the amount of impurities in the CNT based on the concentration of free PAE conjugate polymer, where the amount of impurities in the CNT determines CNT quality.

2. The method of claim 1 wherein the assay solution is filtered with a membrane filter having a filter size of between 0.5 and 1 μm.

3. The method of claim 1 wherein between 15% and 20% w/w of the PAE conjugate polymer is added based on the weight of the CNT.

4. The method of claim 1 wherein the dissolution is carried out by a vibration device.

5. The method of claim 4 in which the vibration device is either a bath sonicator or probe sonicator.

6. The method of claim 1 wherein the solvent is selected from the group consisting of methanol, methyl ethyl ketone (MEK), acetone, chloroform, tetrahydrofuran (THF), organic solvents, and water.

7. The method of claim 1 wherein the PAE (polyaryl ethynyl) conjugate polymer is modified with electron-accepting side chains and/or electron donating side chains.

8. The method of claim 1 wherein the PAE conjugate polymer is poly(phenyleneethynylene).

9. The method of claim 8 wherein the poly(phenyleneethynylene) has the structure Pₐ, P_{b}, P_{c} or a combination thereof: 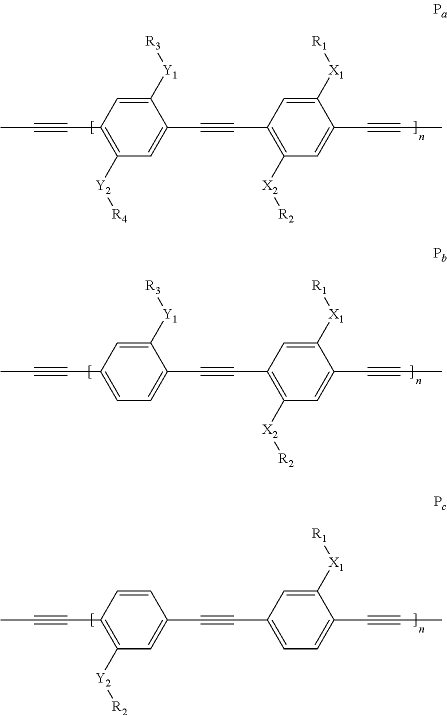
wherein:
n is from about 20 to about 190;
X₁R₁, X₂R₂, Y₁R₃, Y₂R₄, and Y₂R₂ are either electron donating or electron withdrawing substituents;
when the poly(phenyleneethynylene) has the structure Pₐ and when X₁R₁ and X₂R₂ are electron donating, then Y₁R₃ and Y₂R₄ are electron withdrawing, and when X₁R₁ and X₂R₂ are electron withdrawing, then Y₁R₃ and Y₂R₄ are electron donating;
when the poly(phenyleneethynylene) has the structure P_{b} and when X₁Riand X₂R₂ are electron donating, then Y₁R₃ is electron withdrawing, and when X₁R₁ and X₂R₂ are electron withdrawing, then Y₁R₃ is electron donating;
when the poly(phenyleneethynylene) has the structure P_{c} and when X₁R₁ is electron donating, then Y₂R₂ is electron withdrawing, and when X₁R₁ is electron withdrawing, then Y₂R₂ is electron donating;
X₁, X₂, Y₁, and Y₂ are independently CO, COO, CONH, CONHCO, COOCO, CONHCNH, CON, COS, CS, alkyl, aryl, allyl, N, NO, S, O, SO, CN, CNN, SO₂, P, or PO; and
R₁-R₄ are independently alkyl, Z-substituted alkyl, phenyl, Z-substituted phenyl, benzyl, Z-substituted benzyl, aryl, Z-substituted aryl, allyl, Z-substituted allyl or hydrogen, wherein Z is independently an acetal, acid halide, acrylate unit, acyl azide, aldehyde, anhydride, cyclic alkane, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, polyimine (2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine), polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

10. The method of claim 9 wherein at least one of the electron withdrawing groups is a perfluorinated alkyl.

11. The method of claim 1 further comprising comparing the absorbance of an assay solution containing a first CNT with the absorbance of an assay solution containing a second CNT, wherein the quality of the first CNT is determined by comparison to the second CNT.

12. The method of claim 11 wherein the second CNT is a standard or control CNT.

13. A composition comprising
poly(phenyleneethynylene), wherein the poly(phenyleneethynylene) has the structure Pₐ, P_{b}, P_{c} or a combination thereof: 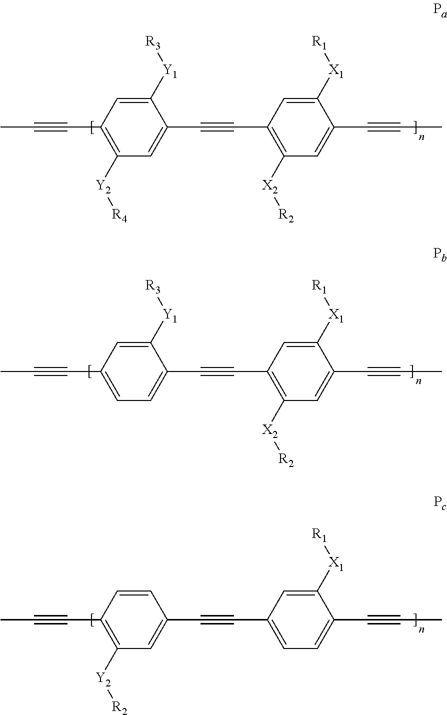
wherein:
n is from about 20 to about 190;
X₁R₁, X₂R₂, Y₁R₃, Y₂R₄, and Y₂R₂ are either electron donating or electron withdrawing substituents;
when the poly(phenyleneethynylene) has the structure Pₐ and when X₁R₁ and X₂R₂ are electron donating, then Y₁R₃ and Y₂R₄ are electron withdrawing, and when X₁R₁ and X₂R₂ are electron withdrawing, then Y₁R₃ and Y₂R₄ are electron donating;
when the poly(phenyleneethynylene) has the structure P_{b} and when X₁R₁ and X₂R₂ are electron donating, then Y₁R₃ is electron withdrawing, and when X₁R₁ and X₂R₂ are electron withdrawing, then Y₁R₃ is electron donating;
when the poly(phenyleneethynylene) has the structure P_{c} and when X₁R₁ is electron donating, then Y₂R₂ is electron withdrawing, and when X₁R₁ is electron withdrawing, then Y₂R₂ is electron donating;
X₁, X₂, Y₁, and Y₂ are independently CO, COO, CONH, CONHCO, COOCO, CONHCNH, CON, COS, CS, alkyl, aryl, allyl, N, NO, S, O, SO, CN, CNN, SO₂, P, or PO; and
R₁-R₄ are independently alkyl, Z-substituted alkyl, phenyl, Z-substituted phenyl, benzyl, Z-substituted benzyl, aryl, Z-substituted aryl, allyl, Z-substituted allyl or hydrogen, wherein Z is independently an acetal, acid halide, acrylate unit, acyl azide, aldehyde, anhydride, cyclic alkane, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, polyimine (2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine), polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

14. The composition of claim 13 wherein at least one of the electron withdrawing groups is a perfluorinated alkyl.

15. The composition of claim 13 or claim 14 further comprising at least one of a solvent or a carbon nanotube (CNT).

16. A kit comprising the composition of claim 13 or claim 14, and instructions for using the composition to determine purity of a carbon nanotube (CNT) composition.
